(19) United States
(12) Patent Application Publication
(10) Pub. No.: US 2015/0310483 A1
(43) Pub. Date: Oct. 29, 2015

(54) DETERMINING APPLICATION CONVERSIONS

(71) Applicants: James Kent, London (GB); Pietro Falcone, London (GB); Andrew Jarrett, Bearsted (GB)

(72) Inventors: James Kent, London (GB); Pietro Falcone, London (GB); Andrew Jarrett, Bearsted (GB)

(73) Assignee: Google Inc.

(21) Appl. No.: 13/404,501

(22) Filed: Feb. 24, 2012

(51) Int. Cl. G06Q 30/02; G06F 15/16

(52) U.S. Cl. CPC G06Q 30/0246; G06Q 30/0273

(57) ABSTRACT

Methods, systems, and apparatus, including computer programs encoded on a computer storage medium, for content presentation. In one aspect, a method includes receiving a request for sponsored content; determining a sponsored content item to provide in response to the request, the sponsored content item being associated with a particular application; providing the sponsored content item for display on a user device; receiving data indicating that the sponsored content item has been selected on the user device; generating and returning a cookie to the user device, the cookie including a cookie identifier associated with the sponsored content item; receiving the cookie identifier in response to a user launch of the application; and logging a conversion event for the sponsored content item using the cookie identifier.

### BACKGROUND

This specification relates to content presentation.

Content providers can provide various forms of sponsored content. For example, advertisers provide advertisements in different forms in order to attract consumers. An advertisement (“ad”) is a piece of information designed to be used in whole or part by a user, for example, a particular consumer. Sponsored content can be provided in electronic form. For example, online ads can be provided as banner ads on a web page, as ads presented with search results, or as ads presented in a mobile application.

### SUMMARY

This specification describes technologies relating to content presentation including determining application conversions of presented sponsored content items.

In particular, a system can provide sponsored content items to user devices. The user devices can present the sponsored content items, e.g., within a browser interface displaying web content or along with application content. The sponsored content items can be associated with an application. For example, the sponsored content item can be an ad for a particular application available for installation on a user device. If a user selects the sponsored content item, a cookie can be stored on the user device. The cookie includes an identifier that is associated with the sponsored content item and/or a particular sponsored campaign. This association can be stored on a sponsored content management system. The user device can also be directed to resources allowing the user to obtain the application, e.g., a landing page for the application on an application market.

If the user downloads and launches the application, this initial launch initiates code for providing conversion information to the sponsored content management system. In particular, the cookie identifier can be sent to the sponsored content management system. The sponsored content management system can use the cookie identifier to identify the corresponding sponsored content item or campaign. As such, the sponsored content management system can log conversion events in which an application identified by a sponsored content item was later installed by a user presented with that sponsored content item. The sponsored content management system can further process additional received data with the cookie identifier to determine whether the conversion event is valid and to generate reports on the success of a sponsored content campaign.

In general, one innovative aspect of the subject matter described in this specification can be embodied in methods that include the actions of receiving a request for sponsored content; determining a sponsored content item to provide in response to the request, the sponsored content item being associated with a particular application; providing the sponsored content item for display on a user device; receiving data indicating that the sponsored content item has been selected on the user device; generating and returning a cookie to the user device, the cookie including a cookie identifier associated with the sponsored content item; receiving the cookie identifier in response to a user launch of the application; and logging a conversion event for the sponsored content item using the cookie identifier. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Logging the conversion event includes using the received cookie identifier to identify the associated sponsored content item. The method further includes associating the cookie identifier with the sponsored content item. Logging the conversion event includes determining whether the conversion event is valid. Determining whether the conversion event is valid includes receiving a unique value with cookie identifier and using the unique value to filter duplicate conversion events. The method further includes using one or more logged conversions to generate conversion reports for a sponsored content provider. The method further includes using one or more logged conversions for recording cost-per-conversion accounting.

In general, one innovative aspect of the subject matter described in this specification can be embodied in methods that include the actions of presenting a received sponsored content item on a user device; receiving a user selection of the sponsored content item; receiving a cookie in response to the user selection, the cookie including a cookie identifier; installing an application, wherein the application is associated with the sponsored content item; initially launching the application; and transmitting the cookie identifier in response to the initial launching of the application. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method further includes invoking a browser session including directing the browser to a specified landing page in response to sponsored content item selection. Content on the landing page identifies the application as available for installation. Initially launching the application includes executing code that invokes a browser session including passing the cookie identifier. Initially launching the application includes executing code that collets additional user device data. Initially launching the application includes executing code that generates a unique value to be passed along with the cookie identifier. Initially launching the applications includes executing code that determines whether the user device has a valid network connection. Initially launching the applications includes executing code that remotely determines whether a sponsored content provider requests continued monitoring of particular activity on the user device.

Particular embodiments of the subject matter described in this specification can be implemented so as to realize one or more of the following advantages. A system can record conversion events associated with installing content following presentation of a sponsored content item. As a result, marketing activity in the form of sponsored content items (e.g., ads) can be linked to subsequent user activity obtaining content identified by the sponsored content items (e.g., an ad for a downloadable application). This linking allows reports to content providers that identify which particular content items, particular content item placements, publishers, etc. that were more successful in leading to conversion events (e.g., application installations).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example content presentation system.

FIG. 2 is a block diagram of an example content presentation system including a mobile device.

FIG. 3 is a flow chart of an example method of identifying an application conversion of a sponsored content item.

FIG. 4 is a flow chart of an example method of installing an application following presentation of a sponsored content item.

Like reference numbers and designations in the various drawings indicate like elements.

### DETAILED DESCRIPTION

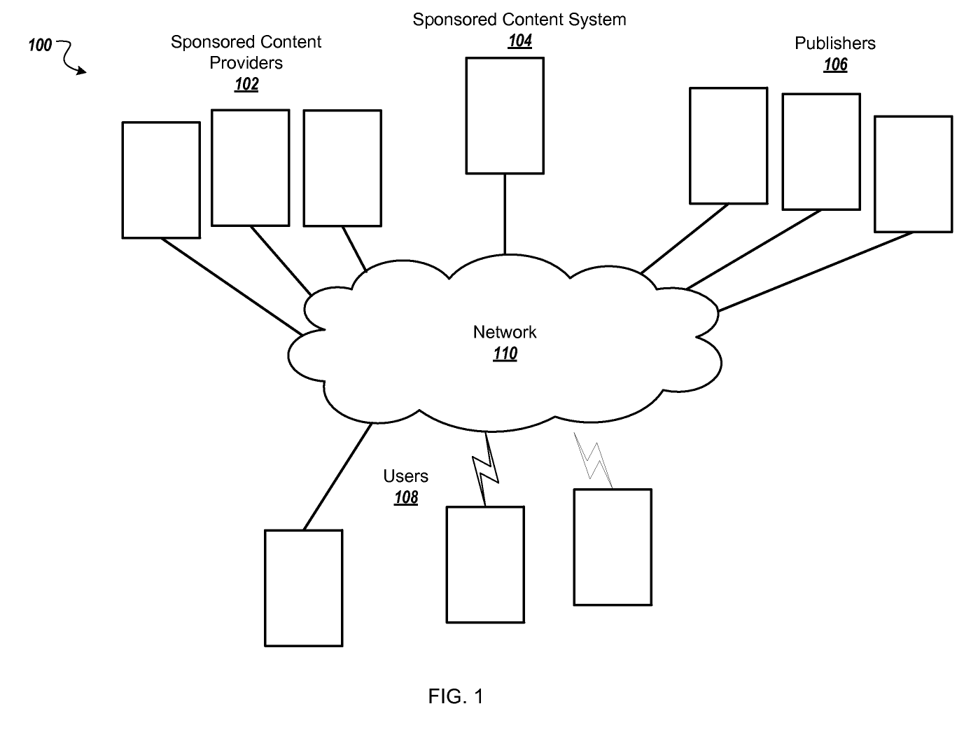

FIG. 1 is a block diagram of an example content presentation system 100. In some implementations, one or more sponsored content providers 102 directly, or indirectly, enter, maintain, and log sponsored content information in a sponsored content management system 104. The sponsored content providers 102 can be, for example, advertisers. Additionally, the sponsored content management system 104 can be an ad management system. Though reference is made to advertising, other forms of content, including other forms of sponsored content, can be delivered by the system 100. The sponsored content can be in the form of graphical ads, for example, banner ads, text only ads, image ads, and barcode ads (e.g., ads that include one or more barcodes used, for example, in ad redemption), audio ads, video ads, animated ads, ads combining one or more of any of such components, etc. The sponsored content can also include embedded information, such as links, meta-information, and/or machine executable instructions or scripts. One or more publishers 106 may submit requests for sponsored content (e.g., ads) to the system 104. The system 104 responds by sending sponsored content items to the requesting publisher 106 for placement on or association with one or more of the publisher's content items (e.g., web properties, mobile applications). Example web properties can include web pages, television and radio advertising slots, or print media space. Example mobile applications can include media players, games, messaging clients, and other applications configured to execute on phones, tablets, and other mobile computing devices.

Other entities, such as users 108, e.g., user devices of various types including mobile, tablet, and desktop computing devices, and the sponsored content providers 102, can provide usage information to the system 104, for example, whether or not a conversion (e.g., a purchase or other interaction) or a click-through related to a sponsored content item (e.g., a user has selected an ad) has occurred. This usage information can include measured or observed user behavior related to sponsored content items that have been served. The system 104 may perform financial transactions, for example, crediting the publishers 106 and charging the sponsored content providers 102 based on the usage information.

A network 110, such as a local area network (LAN), wide area network (WAN), the Internet, one or more telephony networks or a combination thereof, connects the sponsored content providers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for sponsored content items to a sponsored content management server. Alternatively, a request for sponsored content can be embedded in content from the publisher being rendered on a user device (e.g., using an embedded URL for the ad request) such that the user device (e.g., a browser) submits the request. The request can include a number of ads desired. The request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the system 104. The combined content and sponsored content items can be sent/rendered to the users 108 that requested the content for presentation in a viewer (e.g., a browser or other content display system). The content server can transmit information about the sponsored content items back to the advertisement server, including information describing how, when, and/or where the sponsored content items are to be rendered (e.g., in HTML or based on scripting). In some implementations, the content and sponsored content items are combined separately. For example, content can be rendered while waiting for sponsored content items to be received and incorporated into the content.

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search service can submit a request for sponsored content items to the system 104. The request may include a number of sponsored content items desired. This number can depend, for example, on the search results, the amount of screen or page space occupied by the search results, the size and shape of the sponsored content items, etc. The request for sponsored content items may also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

Another example publisher 106 is an application publisher. An application publisher can develop application for a variety of uses on one or more computing platforms. A mobile application is an application specifically designed for operation on a mobile device (e.g., a smart phone). For mobile platforms, network efficiency and computational efficiency may be of importance, based on the resources available to applications executing on mobile platforms.

The mobile applications developed by the application publisher can submit a request for sponsored content items to the system 104 for sponsored content items to display while a user is interacting with or viewing the application. The application may periodically request additional sponsored content items from the system 104, either as a single sponsored content item or a batch of sponsored content items. Each sponsored content item can be displayed for a period of time determined by a refresh rate determined for the application, after which time the sponsored content item can be replaced by a new sponsored content item.

The system 104 can determine one or more candidate sponsored content items. Determining candidate sponsored content items can be based on, for example, the received request information such as keywords based on the publisher content the sponsored content items are being presented with. Determining candidate sponsored content items can also be based on advertisement information, for example, keywords associated with available advertisements. Thus, for example, a candidate sponsored content item can be determined based on a degree of similarity between the request information and advertisement information. Other information can also be used, for example, sponsored content providers can identify particular demographics to which the sponsored content item is directed. In some implementations, scores for landing pages associated with the sponsored content items can be used to determine candidate sponsored content items.

In some implementations, the system 104 can use an auction process to select sponsored content items from the sponsored content providers 102. For example, the sponsored content providers 102 may be permitted to select, or bid, an amount the content providers are willing to pay for each presentation of or interaction with (e.g., click) of an sponsored content item, e.g., a cost-per-click amount an advertiser pays when, for example, a user clicks on an ad. The cost-per-click can include a maximum cost-per-click, e.g., the maximum amount the sponsored content provider is willing to pay for each click of an sponsored content item based on a keyword, e.g., a word or words in a query. Other bid types, however, can also be used. In some implementations, the score of the landing pages can have an effect on the required bid amount for a particular sponsored content item such that higher quality landing pages are favored over lower quality landing pages. Based on these bids, sponsored content items can be selected and ranked for presentation.

The search service can combine the search results with one or more of the sponsored content items provided by the system 104. This combined information can then be forwarded to the users 108 that requested the content. The search results can be maintained as distinct from the sponsored content items, so as not to confuse the user between paid sponsored content items and presumably neutral search results.

In some implementations, one or more publishers 106 submit requests for sponsored content items to the system 104. The system 104 responds by sending sponsored content items to the requesting publisher 106 for placement on one or more of the publisher's web properties (e.g., websites and other network-distributed content) that are relevant to the web property. For example, if a publisher 106 publishes a sports-related web site, the system can provide sports-related sponsored content items to the publisher 106. In some implementations, the requests can instead be executed by devices associated with the user 108, e.g., by the execution of a particular script when the publisher's web page is loading on a client device. For example, content being loaded by a user browser can include scripts indicating a request for sponsored content items is to be made to the system 104. The sponsored content items are requested and can be integrated into the publisher content separately as received or display of the content can be halted until the requested sponsored content items are received.

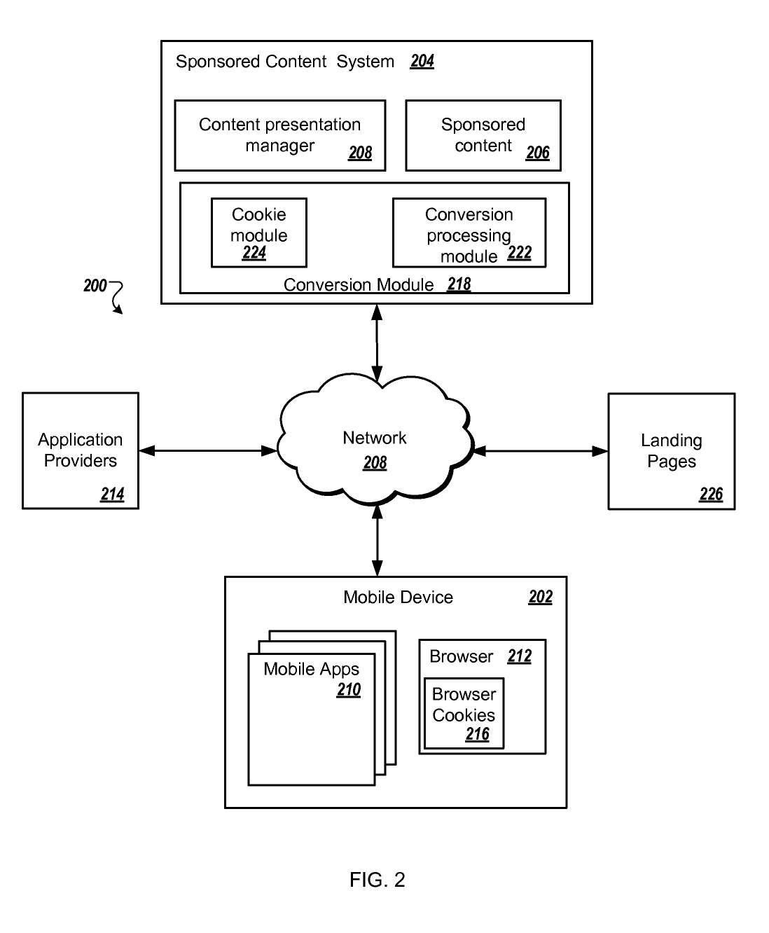

FIG. 2 is a block diagram of an example content presentation system 200 including a mobile device 202.

The system 200 includes a mobile device 202 which can receive sponsored content from an sponsored content system 204. Sponsored content can include one or more sponsored content items 206, including, for example, ads of various types. For example, the sponsored content items can include sponsored content items identifying particular content that can be installed by a user such as an ad for an application that can be installed on a user device. The sponsored content system 204 can serve the sponsored content items to the mobile device 202 for presentation on a user interface of the mobile device 202. The mobile device 202 is a representative example of one of multiple types of user devices that can be communicatively coupled to the system 200 and that can receive sponsored content from the sponsored content system 204.

The mobile device 202 can be a cellular telephone, a smartphone, a personal digital assistant, tablet device, or any other type of mobile device. In this example, the mobile device 202 can be used to make telephone calls, voice over internet protocol (VoIP) calls, and to browse the Internet (e.g., World Wide Web) or other type of network. The mobile device can receive user input, for example, from a touch screen interface, a keyboard, a trackball, or a stylus. The mobile device 202 can communicate to the sponsored content system 204 through a network 208, e.g., the Internet. In other implementations, the network 208 is a LAN, a WAN, or any combination thereof. The mobile device 202 can communicate using a wireless protocol, such as IEEE 802.11, WAP and/or Bluetooth.

The mobile device 202 includes mobile applications 210. In some implementations, one or more of the mobile applications 210 running on the mobile device 202 can request sponsored content from the sponsored content system 204. Types of mobile applications 210 can include games, utilities, news applications, and configuration tools, to name a few examples. The mobile applications 210 can be installed on the mobile device 202 before the device is initially sold by a manufacturer, or the mobile applications 210 can be installed onto the mobile device at a later time (e.g., through a download process from a mobile device application market or installed from portable storage media). In particular, application providers 214 can provide available applications, for free or for sale, to the mobile device 202 (e.g., in response to a user request to purchase or download a particular application). The applications can be platform specific for the particular mobile device 202.

The mobile device 202 includes a browser 212 for browsing the Internet, e.g., the web, or for accessing other content on a network (e.g., documents, images, and other forms of media). The browser 212 can request content from publishers or submit queries for search results, e.g., from a search engine, for display on a user interface of the mobile device 202. Additionally, sponsored content items can be presented with publisher content. For example, sponsored content items can be presented along with web page content rendered by the browser 212. The sponsored content items can be, for example, text ads, image ads, banner ads, etc. In another example, the sponsored content items can be search ads presented along with search results received from a search system (e.g., in response to a search query).

In some implementations, one or more browser cookies 216 are stored on the browser 212 when content is served to the browser 212. A cookie is a piece of data that can be sent to the mobile device 202 as part of an HTML communication to the browser 212. The cookie can include a unique identifier for the cookie. The cookie can also include one or more attributes, for example a particular URL address associated with the cookie. The browser cookies 216 can be used to track the number of times content, such as a web page, is displayed on the user interface of the mobile device 202. The browser cookies 216 can include cookies associated with sponsored content items. These cookies can be used for logging events associated with sponsored content items, e.g., previous impressions of particular sponsored content items presented on the mobile device 202 or conversion events associated with the sponsored content items.

The sponsored content system 204 can send one or more of the sponsored content items 206 to the browser 212 or one or more mobile applications 210 in response to a received request. A content presentation manager 208 can determine particular sponsored content items to present in response to a received request using, e.g., data in the request and/or data associated with the sponsored content 206. An auction process can be used to determine a particular sponsored content item to provide, e.g., from among a group of candidate sponsored content items.

The browser 212 can combine received content, e.g., a web page content or application content, with the received sponsored content items for presentation on a user interface of the mobile device 202. Similarly, a mobile application 210 can insert received content items with application content. The sponsored content system 204 can send one or more cookies to the mobile device 202 for storing information related provided sponsored content items. The mobile device 202 can store the cookies, e.g., along with other browser cookies 216. The cookies can be used, for example, to log which of the sponsored content items 206 were presented on the mobile device 202, advertising events, or a user session on a web site, to name a few examples.

The sponsored content system 204 can include a conversion module 218 for logging conversions for sponsored content items. In particular, the conversion module 218 can log conversions based on a user installation of an application 210 associated with corresponding sponsored content items presented on the mobile device 202. The conversion module 218 includes a cookie module 224 for specifying cookies sent to the mobile device 202 as described above. For example, the cookie module 224 can send a cookie upon detection of user interaction with one of the sponsored content items. In some implementations, the cookie module 224 maintains an association between sent cookie identifiers and their associated sponsored content items or a campaign associated with the sponsored content item.

Additionally, a conversion processing module 222 in the conversion module 218 can determine when a conversion has occurred based on a received cookie identifier and other information from the mobile device 202.

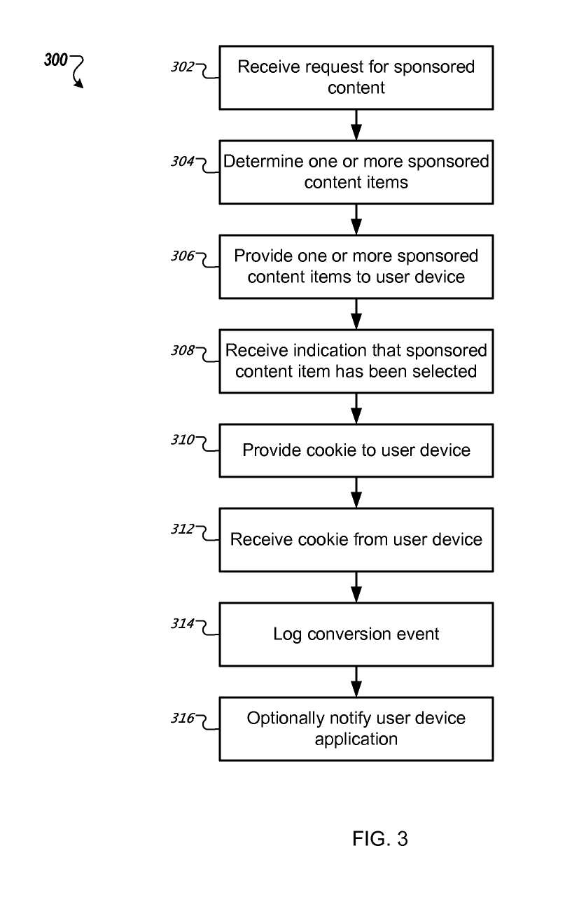

In particular, the browser 212 can request a web page associated with the initial launch of a downloaded application and send the cookie to the conversion module 218. The conversion module 218 can receive cookie information identifying the sponsored content item associated with the launched application as well as additional user data. The user data can include a unique identifier and, optionally, other data, e.g., location information, device identifier, and connection information. This user data can be anonymized, e.g., using a unique identifier to avoid any personally identifying information being transmitted to the sponsored content system 204. Thus, for example, a later installation and activation of an application can be associated with an earlier provided sponsored content item, as will be discussed in greater detail below with respect to FIG. 3.

FIG. 3 is a flow chart of an example method 300 of identifying an application conversion of a sponsored content item. For convenience, the method 300 will be described with respect to a system of one or more computing devices that performs the method 300. For example, the system can be a sponsored content system, e.g., the sponsored content system 204 of FIG. 2.

The system receives a request for sponsored content (302). The request for a sponsored content item (e.g., an ad), can be received by a sponsored content management system (e.g., an ad system) from a user device, e.g., from a device browser or other application. For example, when rendering a web page, the browser can request one or more sponsored content items from the system based on embedded requests in the web page. The one or more sponsored content items received in response can then be rendered into a specified location within the web page. In some other implementations, the request is received from a content publisher, for example, for particular sponsored content to be provided with the published content. Additionally, the system can receive the request for sponsored content, for example, in response to a request from a mobile application on a user device.

The system determines one or more sponsored content items to provide (304). In particular, based on the request and other data, the system identifies the one or more particular sponsored content items, from among a collection of available sponsored content items, to return in response to the request. For example, a request can include one or more associated keywords. The keywords can be used to identify a group of candidate sponsored content items (e.g., based on keywords or other data). An auction process can be held among the candidate sponsored content items to determine the sponsored content item to provide for presentation to the user. Other forms of sponsored content selection can be used. In particular, at least one of the sponsored content items is associated with an application. Specifically, the sponsored content item identifies a particular application. For example, the sponsored content item can be an ad for the application. The sponsored content item can encourage the user to download the application. In some implementations, the sponsored content item can offer one or more incentives for downloading the application (e.g., a discounted price).

The system provides the one or more sponsored content items (306). For example, the one or more sponsored content items can be provided to a client device. The client device can render the received one or more sponsored content items. For example, the client device can render the received one or more sponsored content items in a browser with other content, e.g., with web page content, at a location defined by the web page hypertext markup language (HTML). Alternatively, the client device can render the received one or more sponsored content items within an application, for example, the client device can be a mobile device (e.g., a mobile phone or tablet device) having one or more installed mobile applications.

The system receives indication that a sponsored content item has been selected (308). For example, when a user selects a particular sponsored content item on a device, scripting that is included in the sponsored content item can be activated. This scripting can include transmitting a notification to the system. In some implementations, this includes directing the user to a particular landing page. A landing page can be particular resources identified by a uniform resource locator (URL) address incorporated into the sponsored content item script (e.g., a particular web page). The scripting can invoke a user browser session directed to the landing page URL.

The landing page is usually associated with the content of the sponsored content item. For example, the landing page can provide additional information about an application identified in the sponsored content item or can direct the user to an application market in which the user can download the application.

The system provides a cookie to the user device in response to the received indication (310). The cookie identifies the associated sponsored content item (e.g., using a unique identifier). The cookie can be used to identify the particular sponsored content item or a broader campaign from a particular sponsored content provider that can include one or more sponsored content items, e.g., a particular ad campaign of an advertiser that may include multiple ads.

The cookie has a unique identifier. The unique identifier is associated with the particular sponsored content item or a broader campaign from a particular sponsored content provider and is stored by the system. For example, the system can maintain a table, database, or other data structure that associates cookie identifiers with corresponding sponsored content items or sponsored content campaigns.

The system receives the cookie identifier from the user device in response to the user launching the application associated with the sponsored content item for which the cookie identifier was previously provided (312). Varied periods of time can occur between the time in which the system provides the cookie and the time in which the system receives the cookie depending on when the user installs and launches the associated application. Receiving the cookie identifier allows the system to identify the associated sponsored content item. In particular, the unique identifier of the cookie can be compared with the stored cookie identifiers on the system to match the cookie with the particular sponsored content item or campaign. Thus, receiving the cookie identifier indicates that the application has been installed on a same device that received the associated sponsored content item.

In some implementations, additional data is received with the cookie identifier. For example, application code can be executed on the user device to collect additional information about the user device. This information can include, for example, a device identifier, location data (e.g., city), user demographic information associated, e.g., with a user profile or user input to the application as part of the initial installation or launch such as age group or gender, application data (e.g., versioning), and connection data (e.g., network type such as wi-fi, speed, etc.). Device or user identifying information can be anonymized, e.g., using unique identifiers, prior to transmission to the system. In some implementations, users have the option to opt-out of providing this additional data. In some implementations, privacy policies are further provided by application developers or applications markets.

The system logs a conversion event (314). In particular, the system logs a conversion event for the sponsored content item using the cookie identifier. In addition to determining the sponsored content item or sponsored content campaign associated with the received cookie identifier, the system can perform other processing to determine whether the conversion event is valid. For example, the system can receive a unique value generated by the client application code along with the cookie identifier. This unique value should only be received once. Therefore, any duplicates of this value should be discarded as invalid conversion events.

The system optionally notifies the user device application (316). In particular, the system can notify the user device application that the conversion has been recorded and that the application behavior should return to normal. Thus, the next time the user device launches the application, the application will not send the cookie again.

The system can use logged conversion information to manage a sponsored content campaign. For example, conversions can be used for accounting purposes, e.g., logging a number of conversion events in a campaign including a cost-per-conversion charge to the sponsored content items. The logged conversion information can be used to generate reports to provide to the sponsored content provider with respect to the progress of the sponsored content campaign including success metrics and relative performance of different sponsored content items associated with the same campaign.

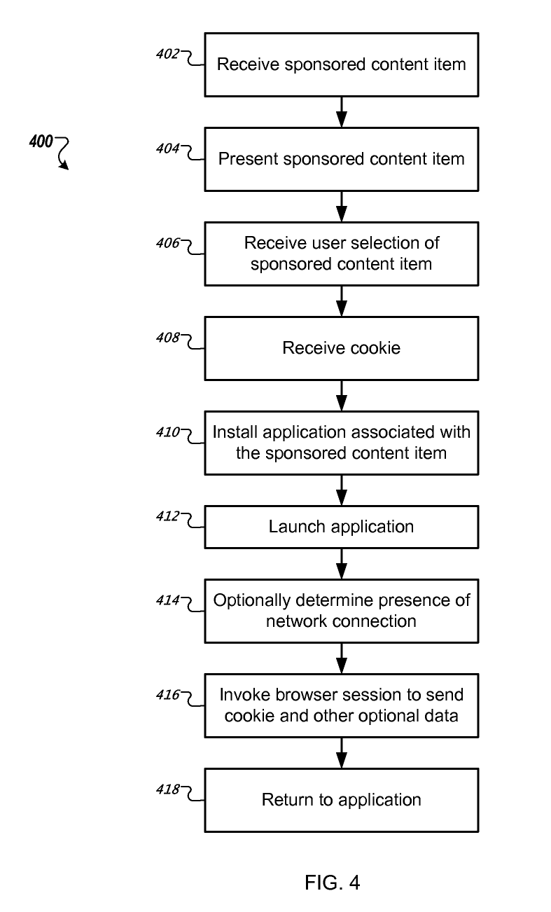

FIG. 4 is a flow chart of an example method 400 of obtaining an application following presentation of a sponsored content item. For convenience, the method 400 will be described with respect to a system of one or more computing devices that performs the method 400. For example, the system can be a mobile device, e.g., the mobile device 202 of FIG. 2.

The system receives a sponsored content item (402). The sponsored content item can be received, for example, by a client device in response to a request. The sponsored content item can be received for presentation, for example, within a web page on a browser or within an application e.g., a mobile application.

The system presents the received sponsored content item (404). The sponsored content item can be presented within rendered content (e.g., web page content). For example, the sponsored content item can be a sponsored content item to be rendered in web content such as a banner ad on a web page or an ad presented along with search results. The sponsored content item can also be presented with application content. For example, a mobile application can provide various content, e.g., news, games, etc., that can also include one or more sponsored content items.

The system receives a user selection of the sponsored content item (406). A user input can be provided that selects the sponsored content item using a particular input device. For example, a user can “click” on a sponsored content item using a mouse or trackball device. Alternatively, the user device can include a touch sensitive display area. The user can select a sponsored content item by touching the sponsored content item using, e.g., a finger or a stylus.

In some implementations, the system directs a browser to a location identified by the sponsored content item in response to the user selection. For example, the location can be identified by a URL address corresponding to a landing page associated with the sponsored content item. The landing page can be a particular web page designated by the sponsored content item. In some implementations, the landing page is a location in which the user can download an application associated with the sponsored content item, e.g., an application market page or a page associated with the application publisher.

The system receives a cookie (408). The cookie can be received from a sponsored content system (e.g., sponsored content system 204). The cookie is received in response to the user selection of the sponsored content item. In some implementations, a request for the cookie is triggered by the sponsored content item. The request can be part of directing the device browser to the landing page associated with the sponsored content item.

The cookie includes an identifier that identifies the particular sponsored content item or a particular sponsor campaign associated with the sponsored content item. The cookie can be a browser cookie stored on the user device.

The system installs the application associated with the selected sponsored content item (410). In some implementations, the system downloads and installs the application from a particular application market or content publisher. In scenarios in which selection of the sponsored content item directs the user to a location in which the application can be downloaded, the system may or may not download the application from that location. The system can also download the application at a later point in time including as part of a separate browser session. Thus, there does not need to be a direct connection between the sponsored content item selection and the subsequent downloading and installation of the associated application. Thus user can instead choose to download the application at a later time and from a provider of their choosing.

The system launches the application for the first time (412). For example, the user can select the application on the user device, e.g., using a touch input to an application icon on a mobile device or tablet device or selecting the application using a cursor or other input device.

The system optionally determines whether or not a valid network connection is present (414). In particular, the system can determine whether or not there is a network connection that would allow communication with the sponsored content system or to retrieve a web landing page. If there is no connection, the process can be halted until a connection is available. The application can be launched and executed as normal while the process is halted. There may be no network connection, for example, based on the location of the user or user input that blocks outgoing signals (e.g., so-called “airplane mode”). When a connection is subsequently present, the process can resume.

The system invokes a browser session to send the cookie identifier and other optional data (416). Launching the application activated code that can perform a number of tasks including invoking a browser session, capturing data from the user device, and sending the cookie identifier to the sponsored content system. In particular, the application code can launch a browser session directing the browser to a specified landing page and including the cookie identifier associated with the application and stored on the user device. In some implementations, the cookie identifier is included in the URL string. In some other implementations, a tag in the landing page content can trigger the transmission of the cookie identifier to the sponsored content system. The cookie identifier can then be used by the sponsored content system to log a conversion event as described above with respect to FIG. 3.

In some implementations, the code activated by the application launch generates a unique identifier to be sent with the cookie identifier. The unique identifier can, for example, include a combination of a randomly generated value and a value specific to the date, time, or device. The unique identifier can be used by the sponsored content system to avoid duplicate conversions.

In some implementations, the code activated by the application launch collects additional data. The additional data can include, for example, a device identifier, location data (e.g., city), user demographic information associated, e.g., with a user profile or user input to the application as part of the initial installation or launch such as age group or gender, application data (e.g., versioning), and connection data (e.g., network type such as wi-fi, speed, etc.). Device or user identifying information can be anonymized, e.g., using unique identifiers, prior to transmission to the system. In some implementations, users have the option to opt out of providing this additional data. The collected additional data can be provided to the sponsored content system along with the cookie identifier.

The browsers session ends after the data has been passed, returning the user device to the application user interface (418). Invoking the browser session, sending the cookie identifier, and returning to the application can be performed without user interaction.

In some implementations, the information including the cookie identifier and optional data is not sent when the application is first launched, but is sent at some later point in time, e.g., based on time of day or other variables. For example, there may not be a network connection available when the application is initially launched. The cookie identifier can be sent at a later time when a network connection is detected. In some other implementations, the cookie identifier and optional data is sent at a later point to minimize user disruption in interacting with the application. For example, the information can be sent at a time or based on criteria specified by the application or application developer, e.g., following particular user interactions (such as button selections) or when a user exits the application the first time.

In some implementations, the application receives a notification of the conversion and instructs the application to proceed normally on subsequent launches.

In some other implementations, e.g., if the system determines that there is a valid network connection when the application is launched, the application can check the value of a remote variable set by the application developer prior to initiating the browser session. If the value is set to TRUE, the application progresses with the normal behavior. If the value is set to FALSE, the application does not report the cookie or initiate the browser session. By doing this, the application developer (or the sponsored content provider) can remotely prevent a disruption of the user experience, e.g., by opening a particular landing page when the application is initially launched, once the particular campaign is finished.

In some further implementations, the application periodically captures data to be sent to the sponsored content system. This data can be similar to that described above and can be triggered in response to particular events, e.g., a user update of the application, user registration of the application, user subscription activity, completion of purchase, or completion of particular application events such as completing a level of a game application or viewing a specified number of articles in a news application.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a request for sponsored content;
determining a sponsored content item to provide in response to the request, the sponsored content item identifying an application available for download to a user device;
providing the sponsored content item for display on a user device;
receiving data indicating that the sponsored content item has been selected on the user device;
generating and returning a cookie to the user device in response to the selection of the sponsored content item on the user device, the cookie including a cookie identifier associated with the provided sponsored content item and the identified application;
receiving, from the user device, the cookie identifier that was generated in response to the selection of the sponsored content item, wherein the cookie identifier is received in response to a user launch of the application associated with the sponsored content item, the application being a mobile application distinct from a browser of the user device, wherein receiving the cookie identifier indicates that the application has been installed on the user device that received the sponsored content item; and
logging a conversion event for the sponsored content item using the received cookie identifier.

2. The method of claim 1, wherein logging the conversion event includes using the received cookie identifier to identify the associated sponsored content item.

3. (canceled)

4. The method of claim 1, wherein logging the conversion event includes determining whether the conversion event is valid.

5. The method of claim 4, wherein determining whether the conversion event is valid includes receiving a unique value with cookie identifier and using the unique value to filter duplicate conversion events.

6. The method of claim 5, further comprising: using one or more logged conversions to generate conversion reports for a sponsored content provider.

7. The method of claim 5, further comprising: using one or more logged conversions for recording cost-per-conversion accounting.

8. A method performed by data processing apparatus, the method comprising:
presenting, by a browser, content including a received sponsored content item on a user device, wherein the sponsored content item identifies an application available for download and wherein the application is a mobile application distinct from the browser;
receiving a user selection of the sponsored content item;
receiving a cookie in response to the user selection, the cookie including a cookie identifier associated with the selected sponsored content item and the identified application;
installing the application associated with the selected sponsored content item, wherein the application is installed from a web page associated with the sponsored content item;
initially launching the application; and
transmitting the cookie identifier that was received in response to the user selection of the sponsored content item, wherein the cookie identifier associated with the selected sponsored content item is transmitted in response to the initial launching of the application that has been installed following selection of the sponsored content item.

9. The method of claim 8, further comprising invoking a browser session including directing the browser to a specified landing page in response to sponsored content item selection.

10. The method of claim 9, wherein content on the landing page identifies the application as available for installation.

11. The method of claim 8, wherein initially launching the application includes executing code that invokes a browser session including passing the cookie identifier.

12. The method of claim 8, wherein initially launching the application includes executing code that collets additional user device data.

13. The method of claim 8, wherein initially launching the application includes executing code that generates a unique value to be passed along with the cookie identifier.

14. The method of claim 8, wherein initially launching the application includes executing code that determines whether the user device has a valid network connection.

15. The method of claim 8, wherein initially launching the application includes executing code that remotely determines whether a sponsored content provider requests continued monitoring of particular activity on the user device.

16. A system comprising:
one or more computing devices and one or more storage devices storing instructions that are configured, when executed by the one or more computing devices, to cause the one or more computing devices to perform operations comprising:
receiving a request for sponsored content;
determining a sponsored content item to provide in response to the request, the sponsored content item identifying an application available for download to a user device;
providing the sponsored content item for display on a user device;
receiving data indicating that the sponsored content item has been selected on the user device;
generating and returning a cookie to the user device in response to the selection of the sponsored content item on the user device, the cookie including a cookie identifier associated with the provided sponsored content item and the identified application;
receiving, from the user device, the cookie identifier that was generated in response to the selection of the sponsored content item, wherein the cookie identifier is received in response to a user launch of the application associated with the sponsored content item, the application being a mobile application distinct from a browser of the user device, wherein receiving the cookie identifier indicates that the application has been installed on the user device that received the sponsored content item; and
logging a conversion event for the sponsored content item using the received cookie identifier.

17. The system of claim 16, wherein logging the conversion event includes using the received cookie identifier to identify the associated sponsored content item.

18. (canceled)

19. The system of claim 16, wherein logging the conversion event includes determining whether the conversion event is valid.

20. The system of claim 19, wherein determining whether the conversion event is valid includes receiving a unique value with cookie identifier and using the unique value to filter duplicate conversion events.

21. The system of claim 20, further configured to perform operations comprising: using one or more logged conversions to generate conversion reports for a sponsored content provider.

22. The system of claim 20, further configured to perform operations comprising:
using one or more logged conversions for recording cost-per-conversion accounting.

23. A system comprising:
one or more computing devices and one or more storage devices storing instructions that are configured, when executed by the one or more computing devices, to cause the one or more computing devices to perform operations comprising:
presenting, by a browser, content including a received sponsored content item on a user device, wherein the sponsored content item identifies an application available for download and wherein the application is a mobile application distinct from the browser;
receiving a user selection of the sponsored content item;
receiving a cookie in response to the user selection, the cookie including a cookie identifier associated with the selected sponsored content item and the identified application;
installing the application associated with the selected sponsored content item, wherein the application is installed from a web page associated with the sponsored content item;
initially launching the application; and
transmitting the cookie identifier that was received in response to the user selection of the sponsored content item, wherein the cookie identifier associated with the selected sponsored content item is transmitted in response to the initial launching of the application that has been installed following selection of the sponsored content item.

24. The system of claim 23, further configured to perform operations comprising invoking a browser session including directing the browser to a specified landing page in response to sponsored content item selection.

25. The system of claim 24, wherein content on the landing page identifies the application as available for installation.

26. The system of claim 23, wherein initially launching the application includes executing code that invokes a browser session including passing the cookie identifier.

27. The system of claim 23, wherein initially launching the application includes executing code that collets additional user device data.

28. The system of claim 23, wherein initially launching the application includes executing code that generates a unique value to be passed along with the cookie identifier.

29. The system of claim 23, wherein initially launching the application includes executing code that determines whether the user device has a valid network connection.

30. The system of claim 23, wherein initially launching the application includes executing code that remotely determines whether a sponsored content provider requests continued monitoring of particular activity on the user device.

31. A non-transitory computer storage medium encoded with a computer program, the program comprising instructions that when executed by one or more computers cause the one or more computers to perform operations comprising:
receiving a request for sponsored content;
determining a sponsored content item to provide in response to the request, the sponsored content item identifying an application available for download to a user device;
providing the sponsored content item for display on a user device;
receiving data indicating that the sponsored content item has been selected on the user device;
generating and returning a cookie to the user device in response to the selection of the sponsored content item on the user device, the cookie including a cookie identifier associated with the provided sponsored content item and the identified application;
receiving, from the user device, the cookie identifier that was generated in response to the selection of the sponsored content item, wherein the cookie identifier is received in response to a user launch of the application associated with the sponsored content item, the application being a mobile application distinct from a browser of the user device, wherein receiving the cookie identifier indicates that the application has been installed on the user device that received the sponsored content item; and
logging a conversion event for the sponsored content item using the cookie identifier.

32. A non-transitory computer storage medium encoded with a computer program, the program comprising instructions that when executed by one or more computers cause the one or more computers to perform operations comprising:
presenting, by a browser, content including a received sponsored content item on a user device, wherein the sponsored content item identifies an application available for download and wherein the application is a mobile application distinct from the browser;
receiving a user selection of the sponsored content item;
receiving a cookie in response to the user selection, the cookie including a cookie identifier associated with the selected sponsored content item and the identified application;
installing the application associated with the selected sponsored content item, wherein the application is installed from a web page associated with the sponsored content item;
initially launching the application; and
transmitting the cookie identifier that was received in response to the user selection of the sponsored content item, wherein the cookie identifier associated with the selected sponsored content item is transmitted in response to the initial launching of the application that has been installed following selection of the sponsored content item.
